(19) United States
(12) Patent Application Publication
(10) Pub. No.: US 2023/0112692 A1
(43) Pub. Date: Apr. 13, 2023

(54) HYBRID DIGITAL INFORMATION STORAGE METHOD AND HYBRID DIGITAL INFORMATION STORAGE ARCHITECTURE

(71) Applicant: MEMENTO CLOUD, Nimes (FR)

(72) Inventor: Nathan RICHARD, Nimes (FR)

(21) Appl. No.: 18/045,865

(22) Filed: Oct. 12, 2022

(30) Foreign Application Priority Data
Oct. 12, 2021 (FR) 2110810
Oct. 12, 2021 (FR) 2110814

(51) Int. Cl. G06F 3/06

(52) U.S. Cl. CPC G06F 3/0619; G06F 3/064; G06F 3/067

(57) ABSTRACT

The hybrid method (100) for storing digital information comprises:
a configuration step (105), which comprises:
a step (120) to define at least two information storage devices, at least one of the devices being local and not dedicated to storage,
a step (125) to create a computer abstraction presenting common addressing characteristics between at least two storage devices, each abstraction being addressable by a central control device,
iteratively, a dynamic step (110) to adjust local storage capacity, comprising:
one step (130) of allocation, by at least one local device not dedicated to storage, of storage capacity and
a step (135) of communication, to the central control device, of an allocated storage capacity and
an execution step (115), which comprises:
a step (140) to trigger a digital information backup,
a step (145) of fragmenting digital information into at least one information segment,
a step (150) of selecting, by the central control device and for each segment, a storage device according to the abstractions created and
a step (155) of recording, on the selected storage device, the associated information segment.

### TECHNICAL FIELD OF INVENTION

The present invention aims at a hybrid digital information storage method and a hybrid digital information storage architecture. It applies in particular to the field of computer data storage.

### STATE OF THE ART

In the field of computer data storage, local storage devices, of the local memories of computer terminals type, such as for example computers, and remote cloud storage devices, are known.

These alternatives can be used in combination, although this hybrid use is performed file by file and manually by a user moving a file from or to a cloud storage or from or to a local directory synchronized with a remote directory.

In addition, the improvement in techniques over the past 20 years has made it possible to increase the storage capacities of computer devices by almost two orders of magnitude at constant prices (from ˜100 GB to ˜10 TB). During the same period, not all business needs for data storage have evolved to the same extent: while new practices such as multimedia production or big data consume high amounts of storage, the increase in office automation needs has been marginal during the same period. As a result, in many organizations, the majority of the storage in IT equipment will never be used during the lifetime of the hardware, which is an economic and ecological waste.

### Introduction to the Invention

The present invention is intended to remedy all or part of these disadvantages. For this purpose, according to a first aspect, the present invention aims at a hybrid method of storing digital information, which comprises:
a configuration step, which comprises:
a step of defining at least two information storage devices, at least one of the devices being local and not dedicated to storage,
a step of creating a computer abstraction presenting common addressing characteristics between at least two storage devices, each abstraction being addressable by a central control device,
iteratively, a dynamic step of adjusting local storage capacity, comprising:
an allocation step, by at least one local device not dedicated to storage, of storage capacity and
a communication step, to the central control device, of an allocated storage capacity and
an execution step, which comprises:
a step to trigger a digital information backup,
a step of fragmenting digital information into at least one information segment,
a step of selecting, by the central control device and for each segment, a storage device according to the abstractions created and
a step of recording, on the storage device selected, the associated information segment.

Thanks to these provisions, the storage of the same file (or any other data computing structure) can be carried out partially on any number of resources, local or remote. In addition, the implementation of non-dedicated local resources, such as a computer implemented regularly by a user running third-party applications, allows optimization of overall memory consumption. The availability of such resources can be updated in real time, as the storage capacity of a local terminal increases or decreases.

Overall, these provisions result in a fine capacity for managing memory resources in a computer network.

In optional embodiments, the execution step comprises an encryption step at the source of an information segment according to a third-party private key.

These embodiments ensure the confidentiality of the stored data, such data may be stored on local terminals belonging to owners other than the owner of the data. In optional embodiments, the configuration step and/or the dynamic adjustment step comprises:
a step of allocation, by at least one third-party storage device located in a third-party computer network in relation to at least one local device, of storage capacity,
a communication step, by at least one third-party device to the central control device, of an allocated storage capacity and
a step of creating, by a calculation system, a computer abstraction presenting common addressing characteristics between at least one local device and at least one third-party device, each abstraction being addressable by a central control device.

These embodiments permit the connection of additional memory resources located outside a user's main network.

In optional embodiments, the fragmentation step comprises:
a step of breaking down the information segment into at least one information block and
one redundancy generation step, for at least one information block,
   the information blocks are saved during the recording step.

These embodiments make it possible to increase the general reliability of the system in order to mitigate the risks of failure of information blocks or storage devices hosting these blocks.

In optional embodiments, at least two segments and/or blocks representative of an initial numerical information are recorded on at least two separate storage devices. These embodiments permit the distribution of the storage of a segment between two separate devices, each storage device being unable to restore all of a digital information thus divided into segments and/or blocks.

In optional embodiments, the execution step comprises a step of determining a unique fingerprint of an information segment and a step of storing the determined digital fingerprint, this fingerprint being configured to be used when reading the recorded information segment to ensure its integrity.

These embodiments mitigate the risks of compromising information blocks or storage devices hosting these blocks.

In optional embodiments, an allocation step is configured to associate at least one availability characteristic with a storage capacity, the selection step being performed according to at least one storage capacity communicated to the central control device.

These embodiments allow fine-tuned management of memory resources in a computer network, according to the available capacities but also the availability criteria of these capacities.

In optional embodiments, an allocation step is configured to associate at least one user identifier with a storage capacity, the selection step being performed according to at least one user identifier communicated to the central control device. These embodiments permit fine-tuned management of memory resources in a computer network, according to the available capacities but also the user identifiers associated with these capacities. This, in particular, prevents all segments and/or blocks from being backed up in storage devices belonging to a single user. In optional embodiments, the configuration step comprises a step of defining a selection strategy, the selection step implementing a defined selection strategy. These embodiments allow fine-tuned management of memory resources in a computer network.

In optional embodiments, the method subject of the present invention comprises, before the recording step on at least one selected storage, a step of local encryption of the segment or block to be recorded according to a random encryption key, this random encryption key being configured to be used when reading the recorded information segment to ensure its integrity.

These embodiments make it possible to significantly reduce the risk of a virus infecting a computer network or terminal, with the segment or block being, when decrypted, re-arranged so that a malicious computer program is rendered inoperative.

In optional embodiments, the central control device is addressable directly by at least one local storage and at least one third-party storage, allowing the formation of a star network between a local and a remote non-local network.

These embodiments make it possible to bypass the limitations linked to interactions in a local network on the one hand and interactions in an Internet network on the other. Indeed, these interactions do not allow a resource in an Internet network to be connected directly to a resource in a local network.

In embodiments, a storage device of a device performing the trigger step is excluded from a list of candidate storage devices at the selection step.

These embodiments improve backup redundancy and optimize the overall memory management of the architecture.

In particular embodiments, the selection step is performed according to:
a value representative of an ongoing or future workload of a storage device,
a value representative of the average processing time of a request by the storage device,
a value representative of the reliability or availability of the storage device and/or
a representative value of carbon emissions linked to the production of electricity used to supply a storage device.

These embodiments allow the allocation of the storage device responsible for the backup to be optimized dynamically and intelligently.

In particular embodiments, the execution step is performed according to execution rules, at least one execution rule being associated with:
a representative value of a number of defined storage devices,
a value representative of a use of the defined storage devices,
a value representative of an execution schedule and/or
a representative value of one of the carbon emissions associated with the production of electricity used to supply a storage device.

These embodiments allow the triggering of the backup to be optimized dynamically and intelligently.

According to a second aspect, the present invention aims at a hybrid digital information storage architecture, which comprises:
at least two information storage devices, at least one of the devices being local and not dedicated to storage, at least one local device comprising:
a means of allocating storage capacity and
a means of communication, to a central control device, of an allocated storage capacity,
a means of configuration, configured to create a computer abstraction with common addressing characteristics between at least two storage devices, each abstraction being addressable by the central control device,
a means of triggering the backup of digital information,
a means of fragmenting digital information into at least one information segment,
the central control device associated with each storage device comprising a means of selecting, by the central control device and for each segment, a storage device according to the abstractions created and
a means of recording, on the storage device selected, the associated information segment.

The advantages of this architecture are identical to the advantages of the method the subject of the present invention.

### BRIEF DESCRIPTION OF THE FIGURES

Other advantages, purposes and particular characteristics of the invention will emerge from the following non-limiting description of at least one particular embodiment of the method and architecture the subjects of the present invention, with respect to the attached drawings, wherein:

FIG. 1 schematically represents, in the form of a flowchart, a particular sequence of steps of the method the subject of the present invention and

FIG. 2 schematically represents a particular embodiment of the architecture the subject of the present invention.

### DESCRIPTION OF EMBODIMENTS

The present description is given on a non-limiting basis, each characteristic of an embodiment can be advantageously combined with any other characteristic of any other embodiment.

Note that the figures are not to scale.

In this description, the term “means of input” refers to any device allowing the transmission of information to a computer system. Such a means of input is, for example, a keyboard, mouse and/or touch screen suitable for interacting with a computer system in order to collect user input. In variants, the means of input is logical in nature, such as a network port of a computer system configured to receive an input command transmitted electronically. Such a means of input can be associated with a graphical user interface (GUI) presented to a user or an application programming interface (API). In other variants, the means of input can be a sensor configured to measure a specified physical parameter relevant to the intended use case.

A “computing device” is any electronic computing device, unit or distributed, capable of receiving digital inputs and providing digital outputs by and to any kind of digital interfaces. Typically, a computing device is a computer running software that has access to data storage, or a client-server architecture in which data and/or at least part of the calculations is performed on the server side while the client side serves as an interface. In variants, a computing device can be a phone or a tablet computer. “Digital information” is any set of digital information that can be interpreted or read by a computing device. Such digital information can be, but is not limited to, a file, image, folder, segment of information from a sensor or computer process, binary, or executable.

A “local storage device” is any computer memory, whatever its type (RAM, read-only memory, volatile memory, flash memory or virtual memory) internalized in a user organization (NAS, computer, server, actually owned by the organization), as opposed to a remote storage whose hardware infrastructure is owned by a third party which provides the system user organization with the enjoyment of storage in the form of a service, accessible from a local network (“Local Area Network”, abbreviated as “LAN”) or a wide-area network.

A “remote storage device” or “third-party storage device” is any computer memory, whatever its type (RAM, read-only memory, volatile memory, flash memory or virtual memory) not accessible from a local network and requiring the implementation of a wide area network (WAN) type data network.

As it is understood in reading the present description, the objective of the present invention is to enhance memory storage spaces not utilized or underutilized of computer parks or computer resources on the cloud belonging to a system user or a third party wishing to exploit its available storage spaces.

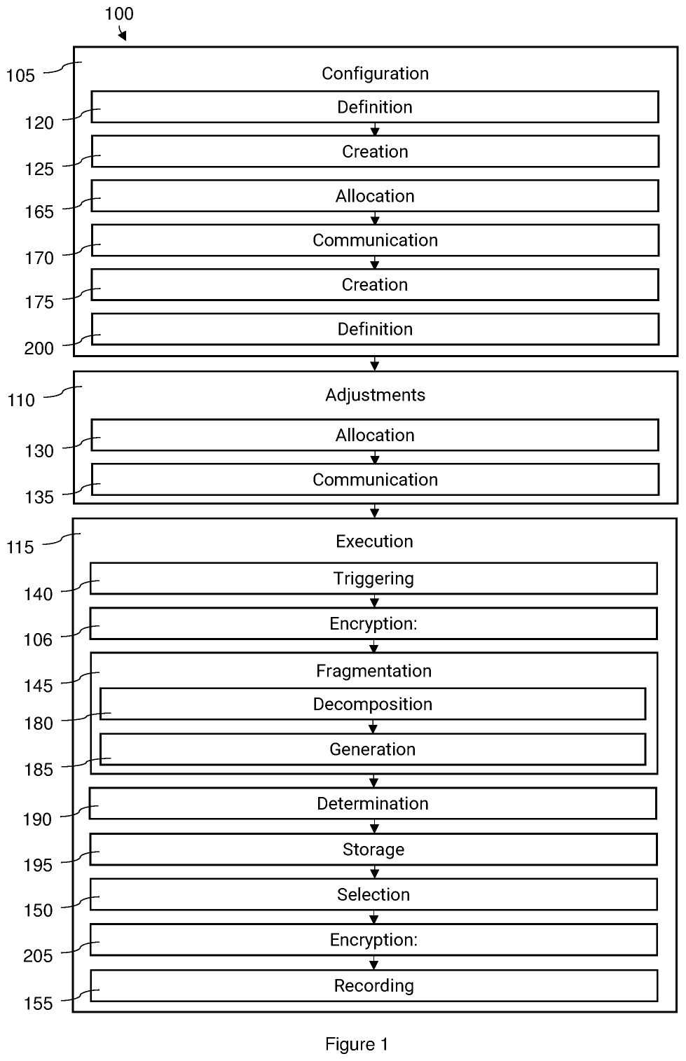

FIG. 1, which is not to scale, shows a schematic view of an embodiment of the method 100 the subject of the present invention. This hybrid method 100 for storing digital information comprises:
a configuration step 105, which comprises:
a step 120 of defining at least two information storage devices, at least one of the devices being local and not dedicated to storage,
a step 125 of creating a computer abstraction presenting common addressing characteristics between at least two storage devices, each abstraction being addressable by a central control device,
iteratively, a dynamic step 110 of adjustment of local storage capacity, comprising:
a step 130 of allocation, by at least one local device not dedicated to storage, of storage capacity and
a step 135 of communication, to the central control device, of an allocated storage capacity and
a step 115 of execution, which comprises:
a step 140 of triggering a digital information backup,
a step 145 of fragmenting digital information into at least one information segment,
a step 150 of selection, by the central control device and for each segment, of a storage device according to the abstractions created and
a step 155 of recording, on the storage device selected, the associated information segment.

The configuration step 105 corresponds to all the steps necessary for the effective execution of the global distributed backup mechanism of digital information. This configuration step 105 can be carried out during the initialization of the method 100 and can be supplemented with secondary configuration steps 105 during the life cycle of the method. Thus, it is possible to add local and/or remote storage devices to an existing park without the need to stop the method 100.

Configuration step 105 can be done by the central control device.

This central control device plays the role of orchestrator of architecture 300 and method 100, the function of this device constituting, on the one hand, observing the presence of storage devices defined as available and, on the other hand, selecting from this set the storage unit(s) on which an information segment must be recorded. The central control device therefore has characteristics of a central register of resources accessible to architecture 300 performing the method 100 and of the actuator of this register. A third responsibility of the control system is to store the mapping of the stored data so that the data can be reconstructed upon restoration. In other words, at the time of restoring a backup, it is necessary to know all the segments, their sequencing, the parameters of the preconditioning operations performed (to be able to reverse them, for example decompression), but also for each segment, the blocks that make it up, their relative sequencing, the redundancy parameters and the device that stores each of these blocks.

As understood, the central control device is preferably addressable directly by at least one local storage and at least one remote storage, allowing the creation of a star communication topology between a local network and a remote non-local network.

Alternatively, step 105 of configuration can be performed by any electronic computing device capable of running a computer program to configure a distributed document storage architecture. Configuration step 105 can also be performed in a distributed manner, i.e., without central authority, for example based on smart contracts of a blockchain-type distributed register technology.

Step 120 of defining at least two information storage devices is performed, for example, by implementing a computing device configured to run a dedicated computer program. During this definition step 120, each storage device is identified by a computer program and associated with an address, in a register of available storage device addresses. This identification and linking to an address can be done automatically or manually. “Manual” is understood to mean a user who, by the use of a means of input, such as a user interface for example, selects at least one storage device to be used by method 100. Automatic completion of the definition step 120 may correspond, for example, to the systematic examination of the memory resources associated with a computing device performing the definition step 120, to the mapping of available resources and to the storage of their computer addresses. Step 125 of creation is performed, for example, by implementing a computing device configured to run a dedicated computer program. During this step 125 of creation, the computing device is configured to create, for each storage device, a unique data schema (or at least shared by two storage devices) transparent from the point of view of a storage device selector looking for a storage address for an information segment. In other words, a local resource and a remote resource are represented by identical data schemes that do not allow software requesting the recording of digital information to know whether the storage device on which the digital information is stored is of the local or remote type.

The dynamic step 110 of adjusting local storage capacity has the function of modulating the general capacity of the architecture according to the resources available at the level of local storage devices. In fact, these non-dedicated devices are used for functions other than storage implemented as part of method 100 and their effective capacities fluctuate as such over time. The adjustment dynamic step 110 can be perceived as an extension of the configuration step 105. The dynamic adjustment step 110 comprises all the steps that make it possible to observe the variation in available resources and to record these variations at the level of the central control device.

The adjustment step 110 can, alternatively, be performed by any electronic computing device capable of running a computer program to configure a distributed document storage architecture. The adjustment step 110 can also be performed in a distributed manner, i.e., without central authority, for example on the basis of smart contracts of a blockchain-type distributed register technology for example. The allocation step 130 is performed, for example, by implementing a computing device configured to run a dedicated computer program. During this step 130 of allocation, a storage capacity corresponding to an amount of memory available for this local device is allocated to the architecture in charge of performing the method 100. This amount of memory can be determined according to a ratio set by a user or required by the central control device, for example 15% of the total memory capacity. In variants, the amount of memory can be determined based on the proportion of unused memory determined locally or based on a usage register of said memory. These dynamic variants allow adaptation of the memory capacity allocated to the architecture based on effective observation of the memory use of the local storage device.

In variants, the allocation step 130 can be associated with allocated capacity availability rules. For example, such a rule may correspond to the availability of an allocated memory capacity according to a storage time and/or duration. Such a duration corresponds, for example, to night hours for a storage device corresponding to a desktop computer.

As understood, step 130 of allocation can be configured to associate at least one availability characteristic with a storage capacity, step 150 of selection being performed according to at least one storage capacity communicated to the central control device.

As understood, step 130 of allocation can be configured to associate at least one user identifier with a storage capacity, step 150 of selection being performed according to at least one user identifier communicated to the central control device. Another parameter that can be taken into account during the allocation step 130 is a parameter representative of an “availability zone” which is different from the availability of a machine depending on whether it is switched on or off). This concept aims to group together devices subject to the same risks (for example, all computers in the same office can be destroyed by a single fire, but two computers in two remote homes may not be destroyed). Grouping resources that can be destroyed at once allows information redundancy to be distributed directly between groups and not between resources, in order to maximize the usefulness of redundancy (avoid losing everything at once).

Step 135 of communication is performed, for example, by implementing a computing device configured to run a dedicated computer program. During this step 135 of communication, any communication protocol over a data network can be implemented. For example, the TCP/IP protocol (transmission control protocol/internet protocol) can be implemented.

The communication step 135 allows the central control device to maintain a register of the storage capacities available for the execution of the method 100.

Compared to the exclusive use of dedicated storage devices, such as servers and NAS (Network Attached Storage), the implementation of local storage devices generates two main issues that can be addressed by architecture design:
the reliability and availability of non-dedicated storage devices is significantly lower than that of dedicated storage devices; the failure rate is higher, it can be switched off at any time by its user, or it can be temporarily unavailable due to a poor connection to the network—the architecture can then implement alternative strategies in the event of unavailability, such as:
when storing a block, if the selected storage device is not available, the system may select another storage device with the same characteristics: i.e. it is guaranteed that a system allocation strategy is respected in any case—for example in the case of an allocation by zone, the unavailable storage device is replaced by another available storage device in the same zone, or a target belonging to a zone not yet used (the contract being that there must not be blocks of the same segment on the same zone) and
when reading a block, if the storage device containing it is not available, the redundancy of the architecture is used to recover the data from another storage device (either a copy of the block in mirror mode or a parity block)—if the architecture detects suspicious behavior from the faulty storage device (e.g. returning a corrupted block at the time of the read request, which may be an attack vector), corrective measures can be taken—these measures comprise blacklisting the storage device (the storage device no longer receives new blocks) and reconstitution of the redundancy lost by moving the reconstituted block to another healthy storage device and
the use of a non-dedicated storage device must not impact its main function (which is therefore not storage), which can be carried out in the following way, for example:
regarding storage, the architecture continuously monitors the available space on each storage device, if the available space falls below a (configurable) alert threshold—for example following the downloading of a large file by the user of the storage device—the architecture refuses the storage of new blocks, even if the capacity allocated to the architecture on this storage device is not reached—this security puts the main functionality of the storage device first, and sacrifices the storage function before it conflicts with the main function and
regarding the use of network, memory and processor resources, this can be reduced to a minimum, for example through software optimization of the architecture—when the local storage device must use resources, it does so over short periods (less than a second, if possible less than 100 milliseconds) so that it remains undetectable for the human user of the storage device.

In optional embodiments, such as the embodiment shown in FIG. 1, the configuration step 105 and/or the adjustment dynamic step comprises:
a step 165 of allocation, by at least one third-party storage device located in a third-party network in relation to at least one local device, of storage capacity,
a step 170 of communication, by at least one third-party device to the central control device, of an allocated storage capacity and
a step 175 of creation, by a calculation system, of a computer abstraction presenting common addressing characteristics between at least one local device and at least one third-party device, each abstraction being addressable by a central control device.

The allocation step 165 is performed, for example, similar to the allocation step 130. The allocation step 165 is dedicated to third-party storage devices accessible, for example, via an API and made available by a non-owner user (or non-member of an owning organization) of the local and/or remote storages implemented by the definition steps 120 and the allocation steps 130.

The communication step 170 is performed, for example, similar to the communication step 135.

Step 175 of creation is performed, for example, in a similar way to step 125 of creation. At the end of this step 175 of creation, a local, remote and third-party storage device can be addressed in an interchangeable and transparent manner. The function of step 115 of execution is to store and/or read files stored in a storage device forming part of the architecture in charge of performing the method 100. Execution step 115 can be performed in parallel or successively to steps 105 of configuration and 110 of adjustment. Execution step 115 may be triggered by any device requiring the recording of digital information, requiring the reading of such digital information or requiring the deletion of such digital information.

Alternatively, step 115 of execution can be performed by any electronic computing device capable of executing a computer program to configure a distributed document storage architecture. Execution step 115 can also be performed in a distributed manner, i.e., without central authority, for example on the basis of intelligent contracts of a blockchain-type distributed register technology, for example.

The triggering step 140 is performed, for example, by implementing a computing device configured to run a dedicated computer program. During this step 140 of triggering, for example, a third-party computer program sends an instruction to back up digital information to the central control device. This instruction can result from a manual or automatic command to back up the digital information.

Some particular embodiments aim to make the trigger step smarter by using the system usage feedback.

For example, a dynamic trigger, based on user preferences (“make at least one backup per day when you feel it is most appropriate”) may be used. The system then has an area of freedom in triggering the backup to optimize it according to different parameters:
number of computers connected—the system can, for example, trigger the backup between 12 pm and 2 pm because according to a user login history, this is the best time in terms of availability of computing power,
use of computer resources—to avoid impacting users' work, the backup is carried out during a 10 am break or after 6 pm, the system using data uploads to choose the appropriate time,
data modification—the modification of a data during backup can create technical difficulties and therefore backups are triggered outside the usual data usage hours or
carbon footprint of electricity—activation of the system is carried out during periods where the energy is decarbonized (off-peak hours, peak solar production, etc.) to limit the impact of the backup—the carbon footprint of electricity can be obtained by connecting to a third-party service.

Thus, as we understand, in particular embodiments, the execution step is performed according to execution rules, at least one execution rule being associated with:
a representative value of a number of defined storage devices,
a value representative of a use of the defined storage devices,
a value representative of an execution schedule and/or
a representative value of one of the carbon emissions associated with the production of electricity used to supply a storage device.

The method 100 comprises a step (not shown) for preconditioning the digital information which may comprise a compression, indexing or statistical analysis step, for example. The preconditioned digital information is then transmitted to the fragmentation step 145.

In particular embodiments, a storage device of a device performing step 140 of triggering is excluded from a list of candidate storage devices at step 150 of selection.

In other words, a transmitting device triggering a backup is not one of the potential storage targets, in such variants.

Step 145 of fragmentation is performed, for example, by implementing a computing device configured to run a dedicated computer program. In this fragmentation step 145, digital information is divided into at least one digital information segment. The numerical information segment thus corresponds to a subdivision of the digital information to be backed up. This step 145 of fragmentation can be performed at the central control device or at a computing device requiring the backup of digital information.

The numerical information may correspond to data representative of information and may be accompanied by additional numerical information including metadata. This additional digital information can also be fragmented.

The size of a fragment can be fixed or variable and fixed during configuration step 105.

This multi-level decomposition approach brings clear advantages over direct storage of digital information:
this approach makes it possible to store large digital information on a collection of devices of which the individual capacity is less than the size of the digital information thanks to the distribution of segments or blocks and
this approach makes it possible to delegate certain pre-conditioning processing to the client digital information computing device performing the storage; for example, encryption is performed entirely at source, and only encrypted data transits and is stored in the other storage devices of the system. If one of these components were compromised by an attacker, encryption would protect data privacy.

In optional embodiments, such as the one shown in FIG. 1, the fragmentation step 145 comprises:
a step 180 of decomposition of the information segment into at least one information block and
a step 185 of generating redundancy, for at least one information block, the information blocks being recorded in step 155 of recording.

The decomposition step 180 is performed, for example, by implementing a computing device configured to run a dedicated computer program. During this decomposition step 180, the information segment is divided into at least one information block, each information block being then recorded on a storage device.

The step 185 of generating redundancy is performed, for example, by implementing a computing device configured to run a dedicated computer program. During this step 185 of generating redundancy, a duplication (mirror mode) or parity mechanism such as an erasure code can be implemented.

In optional embodiments, such as the one shown in FIG. 1, the execution step 115 comprises a step 160 of source encryption of an information segment or original digital information according to a third-party private.

Step 160 of encryption is performed, for example, by implementing a computing device configured to run a dedicated computer program. During this step 160 of source encryption, the initial digital information is encrypted at the device requiring the digital information to be backed up before being transferred to the selected storage device(s). Here the initial encrypted numerical information is, for example, each block independently or each segment independently before the segment is broken down into blocks.

Step 150 of selection is performed, for example, by implementing a computing device configured to run a dedicated computer program. In this selection step 150, at least one storage device is selected from addressable storage devices. This selection can be made according to a registration strategy defined in advance, depending on a user profile or an information segment typology, for example.

In dynamic and intelligent embodiments, the general strategy is defined prior to storage, but specialized according to the system status in real time. For example, this strategy takes into account a number of known dynamic or static properties of storage devices or their environment, such as:
the current workload of a computer
the average processing time of a request (which can vary considerably depending on the request; for example, fast recording and very slow reading),
the reliability or availability of the device (is the computer often turned off or on?) or
the carbon footprint of electricity generation at a given time.

Strategy and its settings are evaluated for each segment, which means that two segments from the same source can be treated differently as the system state changes.

The central system can put in place an expert system (e.g., artificial intelligence) to determine an optimal storage configuration based on the available information and priorities set by the user (e.g., risk reduction, carbon impact reduction, rapid restoration of data).

Thus, as it is understood, in particular embodiments, the selection step is performed according to:
a value representative of an ongoing or future workload of a storage device,
a value representative of the average processing time of a request by the storage device,
a value representative of the reliability or availability of the storage device and/or
a representative value of carbon emissions linked to the production of electricity used to supply a storage device.

Step 155 of recording is performed, for example, by implementing a computing device configured to run a dedicated computer program. During this step 155 of registration, the storage device is configured to store the information segment in a computer memory.

The transmission of the segment to be recorded to the storage device depends on the selected device and how communication with this storage device is performed. In optional embodiments, such as the one shown in FIG. 1, at least two segments and/or blocks representative of initial numerical information are recorded on at least two separate storage devices. The choice of selected devices may depend on a selection strategy.

In optional embodiments, such as the one shown in FIG. 1, step 105 of the configuration comprises a step 200 of defining a selection strategy, the step 150 of selecting implementing a defined selection strategy.

Step 200 of defining a strategy is performed, for example, by implementing a computing device configured to run a dedicated computer program. This selection step 200 can be performed automatically, semi-automatically or manually. For example, a policy can be defined based on a user profile or based on a type of digital information. This policy can be defined in a user interface.

A first example of a strategy is a user-based allocation strategy: it is chosen to distribute blocks among different users, so that the same user does not have several blocks of the same segment. Indeed, if this case occurs, the user has a significant influence on the network with a risk of blackmail being available on the blocks they control. Other parameters can be taken into account, such as the available space of each storage device, its reliability, the speed of its connection, etc.

A second example of a strategy is a zone allocation strategy: it is chosen to divide the blocks into availability zones, i.e., groups of targets with different availability characteristics (for example, all the computers in an office or building form a zone as they can be destroyed by the same fire or stolen together). The aim is to maximize data availability by distributing the redundancy of independent storage devices. Other parameters can be taken into account, such as the available space of each target, its reliability, the speed of its connection, etc.

In optional embodiments, such as that shown in FIG. 1, the method 100 comprises, upstream of step 155 of recording on at least one selected storage, a step 205 of local encryption of the segment or block to be recorded according to a random encryption key, this random encryption key being configured to be used when reading the recorded information segment to ensure its integrity.

Local encryption step 205 is performed, for example, by implementing a computing device configured to run a dedicated computer program. During this step 205 of local encryption, a random encryption key is generated either on the computing device associated with the storage device loaded with the recording or by the central control device. This random key scrambles the binary code of the block or segment, thus disabling any malicious programming instructions that may have been inserted. In optional embodiments, such as the one shown in FIG. 1, the run step 115 comprises a step 190 of determining a unitary fingerprint of an information segment and a step 195 of storing the determined digital fingerprint, this fingerprint being configured to be used when reading the recorded information segment to ensure its integrity.

Step 190 of the fingerprint determination is performed, for example, by implementing a computing device configured to run a dedicated computer program. In this step 190 of determining a fingerprint, for example, a hash of at least one data or metadata of the block and/or information segment is obtained.

Step 195 of storing the fingerprint is performed, for example, by implementing a computing device configured to run a dedicated computer program. During this step 195 of storing the fingerprint, the print is stored in a computer memory associated with the central control device, of the storage device on which the block and/or segment is recorded and/or on the device that required the block and/or segment to be recorded.

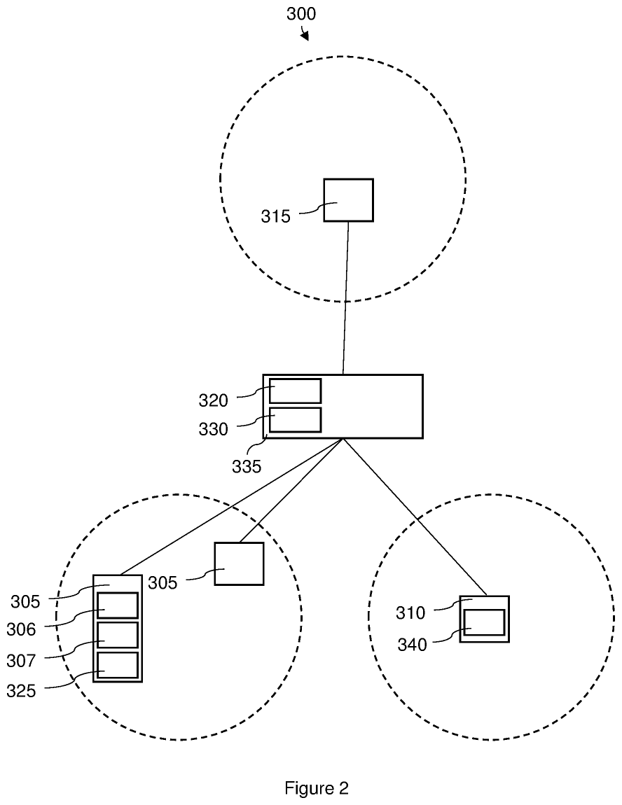

FIG. 2 schematically shows a particular embodiment of the architecture 300 the subject of the present invention. This hybrid architecture 300 for storing digital information comprises:
at least two devices, 305, 310 and 315, for storing information, at least one of the devices 305 being local and not dedicated to storage, at least one local device comprising:
a means 306 of allocating storage capacity and
a means of communication 307, to a central control device 335, with allocated storage capacity,
a configuration means 320, configured to create a computer abstraction presenting common addressing characteristics between at least two storage devices, each abstraction being addressable by the central control device,
a means 325 of triggering backup, by any device of a network connected to the central control device 335, of digital information,
a means 330 of fragmenting digital information, by any device in a network connected to the central control device 335 or by the central control device 335, into at least one information segment,
the central control device 335 associated with each storage device comprising a means of selecting, by the central control device and for each segment, a storage device according to the abstractions created and
a means 340 of recording the associated information segment on the selected storage device.

The means implemented, as well as their variants, to produce architecture 300 are described opposite the description in FIG. 1.

In a variant of architecture 300, this architecture comprises an IT agent installed on a computing device (computer or computer server for example) that may interact with the central control device, the central control device and the storage devices.

For example, the IT agent comprises two main functions:
make accessible a computer memory associated with the computing device to the central control device, corresponding to step 120 of definition or step 130 of allocation, for example, and
restore or backup data, on a storage device associated with the computing device.

The central control device 335 is, for example, configured to allow or deny data transfers between IT agents and to store a network mapping containing storage resource addresses as well as stored digital information addresses.

The central control device 335 can also trigger the backup or restore of digital information.

IT agents can communicate directly with each other or use the central 335 control device as a gateway.

As understood in reading this description, the present invention also targets a method of restoring or reconstituting digital information stored in a distributed manner. The exact nature of this restoration method involves the reverse steps of the storage method used.

In a minimal version, such a restoration method consists of:
a step of triggering a request to restore digital information,
a step to determine at least one storage address for at least one block or segment of digital information,
a collection step, for each address determined, for each block or segment,
optionally, a step of assembling a plurality of blocks to form a segment of digital information and
optionally, a step of assembling a plurality of segments to form the digital information.

Other, more advanced versions may implement reverse processing steps of preconditioning performed on digital information, a segment and/or a block. For example, if the storage method implements a step of encrypting digital information, then a step of splitting into segments and/or blocks, then a step of distributing digital information split up on a plurality of devices and a step of storing, distributed, of the digital information, the restoration method comprises a step of reading distributed digital information, a step of grouping distributed digital information, a step of reconstituting digital information, and a step of decrypting reconstituted digital information.

Such a restoration process is therefore implicitly disclosed here, by performing steps in reverse to those performed during the storage process.

1. Hybrid method for storing digital information, comprising:
a configuration step, which comprises:
a definition step at least two information storage devices, at least one of the devices being local and not dedicated to storage,
a creation step of a computer abstraction presenting common addressing characteristics between at least two storage devices, each abstraction being addressable by a central control device,
iteratively, a dynamic adjustment step of local storage capacity, comprising:
an allocation step, by at least one local device not dedicated to storage, of storage capacity and
a communication step, to a central control device, of an allocated storage capacity and
an execution step, which comprises:
a triggering step for a digital information backup,
a fragmenting step of digital information into at least one information segment,
a selecting step, by the central control device and for each segment, of a storage device according to the abstractions created and
a recording step, on the selected storage device, of the associated information segment.

2. Method according to claim 1, wherein the execution step comprises a source encryption step of an information segment according to a third-party private key.

3. Method according to claim 1, wherein the configuration step and/or the dynamic adjustment step comprises:
a step of allocation, by at least one third-party storage device located in a third-party computer network in relation to at least one local device, of storage capacity,
a step of communication, by at least one third-party device to the central control device, of an allocated storage capacity and
a step of creating, by a calculation system, a computer abstraction presenting common addressing characteristics between at least one local device and at least one third-party device, each abstraction being addressable by a central control device.

4. Method according to claim 1, wherein the central control device is addressable directly by at least one local storage and at least one third-party storage, allowing the formation of a star network between a local and a remote non-local network.

5. Method according to claim 1, wherein the fragmentation step comprises:
a step of breaking down the information segment into at least one information block and
a step of generating redundancy, for at least one information block, the information blocks being recorded during the recording step.

6. Method according to claim 1, wherein at least two segments and/or blocks representative of initial digital information are recorded on at least two separate storage devices.

7. Method according to claim 1, wherein the executing step comprises a step for determining a unitary fingerprint of an information segment and a step for storing the determined digital fingerprint, such fingerprint being configured to be used when reading the recorded information segment to ensure its integrity.

8. Method according to claim 1, wherein an allocation step is configured to associate at least one availability characteristic with a storage capacity, the selection step being performed according to at least one storage capacity communicated to the central control device.

9. Method according to claim 1, wherein an allocation step is configured to associate at least one user identifier with a storage capacity, the selection step being performed according to at least one user identifier communicated to the central control device.

10. Method according to claim 1, wherein the configuration step comprises a step of defining a selection strategy, the step of selection implementing a defined selection strategy.

11. Method according to claim 1, which comprises, upstream of the step of recording on at least one selected storage, a step of local encryption of the segment or block to be recorded according to a random encryption key, this random encryption key being configured to be used when reading the recorded information segment to ensure its integrity and to protect the storage device from introduction of malicious code.

12. Method according to claim 1, wherein a storage device of a device performing the triggering step is excluded from a list of candidate storage devices at the selection step.

13. Method according to claim 1, wherein the step of selection is performed according to:
a value representative of an ongoing or future workload of a storage device,
a value representative of the average processing time of a request by the storage device,
a value representative of the reliability or availability of the storage device and/or
a representative value of carbon emissions linked to the production of electricity used to supply a storage device.

14. Method according to claim 1, wherein the step of execution is performed according to execution rules, at least one execution rule being associated with:
a representative value of a number of defined storage devices,
a value representative of a use of the defined storage devices,
a value representative of an execution schedule and/or
a representative value of one of the carbon emissions associated with the production of electricity used to supply a storage device.

15. Hybrid architecture for storing digital information, comprising:
at least two devices for storing information, at least one of the devices being local and not dedicated to storage, at least one local device comprising:
a means of allocating storage capacity and
a means of communication to a central control device of an allocated storage capacity,
a configuration means configured to create a computer abstraction presenting common addressing characteristics between at least two storage devices, each abstraction being addressable by the central control device,
a means of triggering the backup of digital information,
a means of fragmenting digital information into at least one information segment,
a central control device associated with each storage device comprising a means of selecting, by the central control device and for each segment, a storage device according to the abstractions created, and
a means of recording, on the storage device selected, the associated information segment.
